(19) United States
(12) Patent Application Publication
(10) Pub. No.: US 2026/0085764 A1
(43) Pub. Date: Mar. 26, 2026

(54) SPRING ASSEMBLIES FOR PRESSURE RELIEF VALVES

(71) Applicant: Emerson Automation Solutions Final Control US LP, Houston, TX (US)

(72) Inventors: Liang Hongkang, Shanghai (CN); Baisen Ye, Shanghai (CN); Katherine Si, Stafford, TX (US)

(21) Appl. No.: 19/331,645

(22) Filed: Sep. 17, 2025

(30) Foreign Application Priority Data
Sep. 24, 2024 (CN) 202411331380.7

(51) Int. Cl. F16K 17/04; F16K 49/00

(52) U.S. Cl. CPC F16K 17/044; F16K 17/0493; F16K 49/00

(57) ABSTRACT

A spring assembly for a spring-operated relief valve can include a first spring washer, a second spring washer, a plurality of springs arranged between the first spring washer and the second spring washer to be compressed by movement of the second spring washer toward the first spring washer, and a first spring guide secured to the first spring washer. The first spring guide to one of define a central guide opening that defines a first inner guide profile that receives one or more springs of the plurality of springs or define a first outer guide profile that is received within one or more springs of the plurality of springs. During compression of the plurality of springs, the first spring guide maintains radial alignment of the plurality of springs relative to the first and second spring washers.

### CROSS-REFERENCE TO RELATED APPLICATIONS

This application is based on and claims the benefit of priority from Chinese Patent Application No. 202411331380.7 filed on Sep. 24, 2024, which is hereby incorporated by reference in its entirety.

### BACKGROUND

Spring-operated pressure relief valves are used extensively in systems and vessels where pressure protection is required. For example, in such systems, excess pressure can lead to process upset, instrument failure, or equipment failure. Pressure relief valves allow excess pressure to be relieved by allowing fluid that exceeds a set pressure to flow out of the system.

### SUMMARY

According to one aspect of the present disclosure, a spring assembly for a spring-operated relief valve can include a first spring washer and a second spring washer. A plurality of springs can be arranged between the first spring washer and the second spring washer to be compressed by movement of the second spring washer toward the first spring washer. A first spring guide can be secured to the first spring washer, where the first spring guide can define a central guide opening that defines a first inner guide profile that receives one or more springs of the plurality of springs, or can define a first outer guide profile that is received within one or more springs of the plurality of springs. During compression of the plurality of springs, the first spring guide can maintain radial alignment of the plurality of springs relative to the first and second spring washers.

In some examples, the spring assembly can further include a second spring guide. The first spring guide can define the central guide opening that receives the one or more springs of the plurality of springs. The second spring guide can define a second outer guide profile that is received within the one or more springs of the plurality of springs to further maintain radial alignment of the plurality of springs relative to the first and second spring washers.

In some examples, the first spring guide can be a first spring guide cylinder secured to an outer diameter of the first spring washer. The second spring guide can be second spring guide cylinder secured to an inner pedestal of the second spring washer.

In some examples, a length of the first spring guide between the first and second spring washers can be between about 30 percent and about 50 percent of a length of the second spring guide between the first and second spring washers.

In some examples, the first spring guide can extend axially from the first spring washer toward the second spring washer. The second spring guide can extend axially from the second spring washer toward the first spring washer, to axially overlap with the first spring guide.

In some examples, the first spring guide can define the central guide opening. A length of the first spring guide in a direction of compression of the plurality of springs can be longer than a collective length of the plurality of springs in the direction of compression, as measured with the plurality of springs in a pre-compressed state corresponding to the spring-operated relief valve being in a closed configuration.

In some examples, the first spring guide can define a plurality of thru-openings along the one of the first inner guide profile or the first outer guide profile to provide gas exchange to cool the plurality of springs.

In some examples, the plurality of springs can include a plurality of disk springs.

In some examples, the first spring guide can define the first outer guide profile. An axial gap can be defined, in a direction of compression of the plurality of springs, between the first spring guide and the second spring washer, where the axial gap can permit compression of the plurality of springs to open the spring-operated relief valve without contact between the first spring guide and the second spring washer. A radial gap can be defined in a radial direction between the plurality of springs and the one of the first inner guide profile or the first outer guide profile, where the radial gap can permit radial movement of the first spring guide relative to the plurality of springs.

According to another aspect of the present disclosure, a spring-operated relief valve can include a valve body that defines an inlet and an outlet. A valve seat can be positioned along a flow path between the inlet and the outlet. A spindle assembly can include a valve trim assembly, a spindle, and a spring assembly. The spring assembly can include a first spring washer and a second spring washer engaged with the spindle assembly to be moved toward the first spring washer by an opening movement of the valve trim assembly relative to the valve seat. A plurality of springs can be arranged between the first spring washer and the second spring washer to be compressed by movement of the second spring washer toward the first spring washer. A first spring guide cylinder can be secured to the first spring washer, where the first spring guide cylinder can surround the spindle assembly and can define a central guide opening that defines a first cylindrical inner guide profile that surrounds the plurality of springs, or can define a first cylindrical outer guide profile that is received within the plurality of springs.

In some examples, the spring-operated relief valve can further include a second spring guide cylinder secured to the second spring washer. The first spring guide cylinder can define the central guide opening that surrounds the plurality of springs. The second spring guide cylinder can define a second cylindrical outer guide profile that is received within the plurality of springs to further maintain radial alignment of the plurality of springs.

In some examples, the first spring guide cylinder can define the central guide opening. A length of the first spring guide cylinder in a direction of compression of the plurality of springs can be longer than a collective length of the plurality of springs in the direction of compression, as measured with the plurality of springs in a pre-compressed state corresponding to the spring-operated relief valve being in a closed configuration.

In some examples, the first spring guide cylinder can define a plurality of thru-openings along the one of the first cylindrical inner guide profile or the first cylindrical outer guide profile to provide gas exchange to cool the plurality of springs.

In some examples, the spring-operated relief valve can further include a pressure adjustment assembly engaged with the spring assembly to adjust a compression of the plurality of springs and thereby adjust a set pressure of the spring-operated relief valve.

In some examples, the first spring washer can include one or more alignment tabs and the first spring guide cylinder can include one or more corresponding alignment slots configured to engage with the one or more alignment tabs to prevent relative rotation between the first spring washer and the first spring guide cylinder.

According to yet another aspect of the present disclosure, a method of assembling a spring assembly for a spring-operated relief valve can include positioning a plurality of springs between a first spring washer and a second spring washer. A first spring guide can be secured to the first spring washer, where the first spring guide can define a central guide opening that defines a first inner guide profile that receives one or more springs of the plurality of springs, or can define a first outer guide profile that is received within one or more springs of the plurality of springs. The plurality of springs can be compressed by moving the second spring washer toward the first spring washer, where the first spring guide can maintain radial alignment of the plurality of springs relative to the first and second spring washers during compression.

In some examples, the method can further include securing a second spring guide to the second spring washer, where the second spring guide can define a second outer guide profile that is received within the one or more springs of the plurality of springs to further maintain radial alignment of the plurality of springs.

In some examples, securing the first spring guide to the first spring washer can include engaging one or more alignment tabs of the first spring washer with one or more corresponding alignment slots of the first spring guide to prevent relative rotation between the first spring washer and the first spring guide.

In some examples, the first spring guide can define a plurality of thru-openings to provide gas exchange to cool the plurality of springs during operation of the spring-operated relief valve.

In some examples, a length of the first spring guide in a direction of compression of the plurality of springs can be longer than a collective length of the plurality of springs in the direction of compression, as measured with the plurality of springs in a pre-compressed state.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a side elevation view of a pressure relief valve according to aspects of the present disclosure.

FIG. 2 is an exploded view of an example spring assembly for use with the pressure relief valve of FIG. 1.

FIG. 3 is a side elevation view of the spring assembly of FIG. 2.

FIG. 4 is a cross-sectional view of the spring assembly of FIG. 2.

FIG. 5 is a first axonometric view of the spring assembly of FIG. 2.

FIG. 6 is a cross-sectional view of the spring assembly of FIG. 2 taken along line XI-XI shown in FIG. 3.

FIG. 7 is a cross-sectional view of a second spring guide taken along line XII-XII shown in FIG. 2.

FIG. 8 is an exploded view of another example spring assembly for use with the pressure relief valve of FIG. 1.

FIG. 9 is a side elevation view of the spring assembly of FIG. 8.

FIG. 10 is a cross-sectional view of the spring assembly of FIG. 8.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As briefly discussed above, certain systems and vessels require pressure protection to avoid over-pressurization. Spring-operated pressure relief valves can be used in such systems to relieve and divert excess fluid pressure. In general, spring-operated pressure relief valves include a spring that is compressed by a predetermined value. The spring provides a force on a trim assembly in a valve-closing direction (e.g., applies a downward force on a valve disc), thereby biasing the valve toward a closed (i.e., no-flow) position. The compression of the spring can be adjusted via a spring adjustment mechanism, such as an adjustable screw that controls the degree of compression of the spring for a given valve lift. When an opening (e.g., upward) force exerted by a pressurized fluid acting on the valve disc exceeds the closing (e.g., downward) force of the spring, plus any ancillary forces (e.g., due to the weight of a disc assembly), the valve begins to open. As the fluid pressure continues to increase, the spring is further compressed, and the valve is further opened.

Spring-operated pressure relief valves are generally configured to provide a set pressure, which is typically predetermined and preset before installation of the valves. The set pressure is typically a pressure at which the valve opens and there is a significant relief of system pressure, although other definitions are applied in different installations, as is known in the industry. In some instances, the set pressure may be defined as the pressure at which a first audible response (i.e., “pop”) can be heard by a user, as a spring-operated pressure relief valve releases system pressure. Or the set pressure may be defined as the pressure at which leakage through a valve is first audible for human operators (e.g., corresponds to a predetermined decibel level). As appropriate, the set pressure for a particular valve can be adjusted by varying the compression of a spring within the valve, including by adjusting a pressure adjustment screw to compress or release a spring by a certain amount.

In addition to a set pressure, spring-operated pressure relief valves further define a crack pressure. The crack pressure is a pressure at which the disc assembly of the valve first begins to lift from the valve seat in response to system pressure. In other words, the crack pressure may be defined as a pressure at which the force of the fluid on a line side of the valve seat equals the force exerted by the spring (and any ancillary forces) on a relief side of the valve seat. The effect of a system reaching crack pressure can be minute fluid leakage or a low decibel audible noise (e.g., which may not necessarily be audible to human operators). In some cases, when a spring-operated pressure relief valve is at crack pressure, the valve disc may lift from the valve seat by a relatively small distance. In some systems, the set pressure value can be larger than a crack pressure value by a small percentage (e.g., 3-5%), such that a set pressure can be defined relative to a crack pressure (or vice versa), although other approaches are possible.

In some examples, specifically in high-pressure application, currently-known spring-operated relief valves may be unable to provide the spring force needed to resist pressure on the valve below a desired set point, without being overly large or cumbersome. Examples of the disclosed technology can address this issue or others, in some examples, by allowing the use of a spring assembly with a disk-type spring (e.g., a Belleville spring).

In some examples, a spring assembly according to the disclosed technology may include a spring set (e.g., an axial array of a plurality disk-type springs) that is sandwiched between a first spring washer and a second spring washer. The first and second spring washers may provide a compression (e.g., preload) force on the spring, which may determine the set/crack pressure for the relevant valve. In some examples, to mitigate the risk of radial displacement of one or more of the relevant springs (e.g., during compression/expansion of the spring assembly), the spring assembly may include one or more spring guides (e.g., a first spring guide and a second spring guide).

In some examples, a first spring guide may be secured to the first spring washer and may circumferentially surround an exterior of the spring set. Thus, the first spring guide may help guide and contain movement of the spring set during compression (e.g., via an inner cylindrical guide profile that surrounds the springs of the set). Further, a second spring guide may be secured to the second spring washer and may be arranged within a central aperture of the spring set. Thus, the second spring guide may also (or alternatively) help to guide and contain movement of the spring set during compression (e.g., via an outer cylindrical guide profile that extends through central apertures of the springs of the set). In some examples, the first spring guide may define a length that is about 30-50 percent of the length of the second spring guide, and may axially overlap with the second spring guide along the set of springs.

In some examples, a spring assembly may only include a single spring guide, rather than two spring guides. For example, a first spring guide can be arranged circumferentially around the set of springs (e.g., to constrain and guide movement of the springs via an inner cylindrical guide profile). In some examples, the length of the spring guide may be longer than a length of the set of springs. Thus, for example, the spring guide may radially contain (or otherwise constrain) the springs over a full range of states of the relevant valve.

In some examples, the first and second spring guides may define one or more openings. For example, an array of holes may extend radially through the cylindrical wall(s) of a first or a second spring guide. In some examples, such an arrangement can help to reduce a total weight of the spring assembly, without loss of structural stability for the set of springs. In some examples, the openings may permit the flow of fluid (e.g., air) throughout the spring assembly, which may reduce the risk of overheating the spring and allow the relevant relief valve to be used in relatively high temperature applications.

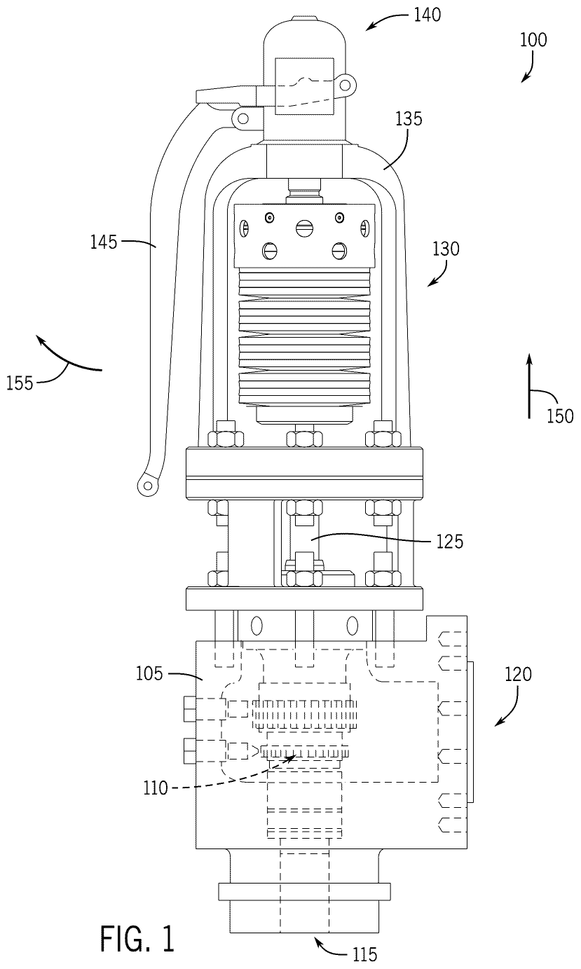

Referring now to FIG. 1, an example of a spring-operated pressure relief valve 100 is shown. In some examples, the spring-operated operated relief valve 100 includes a valve body 105, which may contain a valve trim 110 with various corresponding components (e.g., valve stem, plug, disk, seat with seating surface, etc.). The valve body 105 may further define a fluid inlet 115 and a fluid outlet 120. Generally, the relief valve 100 may be configured to vent (e.g., release) fluid from the fluid outlet 120 when a fluid pressure at the fluid inlet 115 reaches a predetermined value (e.g., pressure).

In some examples, in order to provide adjustability for a set pressure, the relief valve 100 may include a pressure adjustment assembly 140 engaged with a spring assembly 130. For example, the pressure adjustment assembly 140 may be engaged with the spring assembly 130 so that adjustment of the pressure adjustment assembly 140 may modify a vent pressure of the relief valve 100. In some examples, the spring assembly 130 is configured to bias a valve stem 125 downwards (e.g., towards the valve body 105) to maintain the relief valve 100 in a normally closed position (e.g., to prevent the flow of fluid from the fluid inlet 115 to the fluid outlet 120). Correspondingly, a pressure adjustment screw or other device of the pressure adjustment assembly 140 can be used to adjust a compression of the spring assembly 130 when the relief valve 100 is closed and thereby correspondingly adjust a pressure applied by the spring assembly 130 to keep the relief valve 100 closed. In some examples, the pressure adjustment assembly 140 may thus include threaded components to threadably adjust a spring compression, levers, or other similar arrangements to apply mechanical force, as variously known in the art.

In some examples, the relief valve 100 may further include a bonnet 135 that at least partially covers the spring assembly 130. The bonnet 135 may mitigate the risk of damage to or accidental misalignment of the spring assembly 130. In some examples, the relief valve 100 may additionally include a handle 145. The handle 145 may permit an operator to manually release pressure to permit flow out of the fluid outlet 120. For example, an operator may grasp and actuate the handle 145 in the direction shown by arrow 155, which may actuate the valve stem 125 in the direction shown by arrow 150. As a result, the valve stem 125 may lift off of a valve seat of the valve trim 110, which may permit the flow of fluid from the fluid inlet 115 to the fluid outlet 120 (e.g., to vent or release fluid from the protected system).

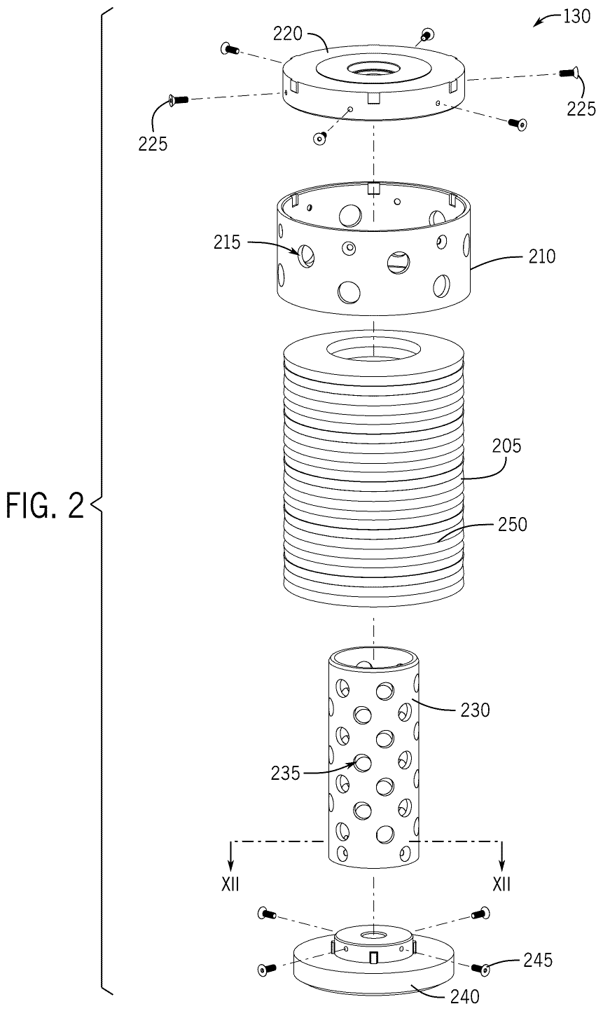

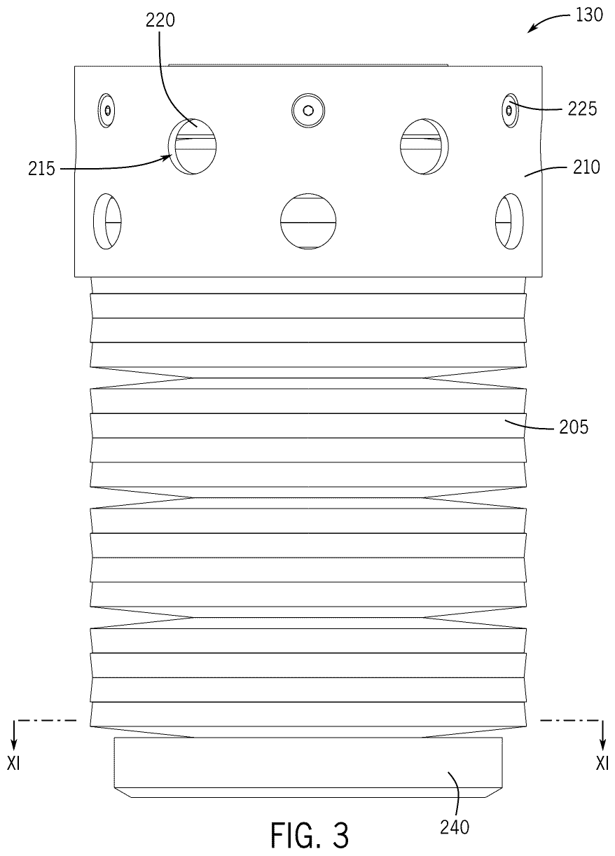

FIGS. 2-4 illustrate an example of the spring assembly 130. As mentioned previously, the spring assembly 130 may apply a biasing force to the valve stem 125 to prevent the flow of fluid from the fluid inlet 115 to the fluid outlet 120 until pressure at the fluid inlet 115 is sufficiently elevated (e.g., exceeds the valve set pressure). In some applications, the spring assembly 130 include an axial array of springs 205 (e.g., a stack of disk spring), which supplies a sufficiently large biasing force in order to withstand the pressures at the fluid inlet 115. Such an arrangement may be particularly applicable in relatively high pressure applications, although similar systems can be used across a range of expected pressure. In some examples, one or more (e.g., each) of the springs 205 may be in the form of a Bellville spring. However, other forms of spring (e.g., other disk springs, coil springs, wave springs, etc.) are possible.

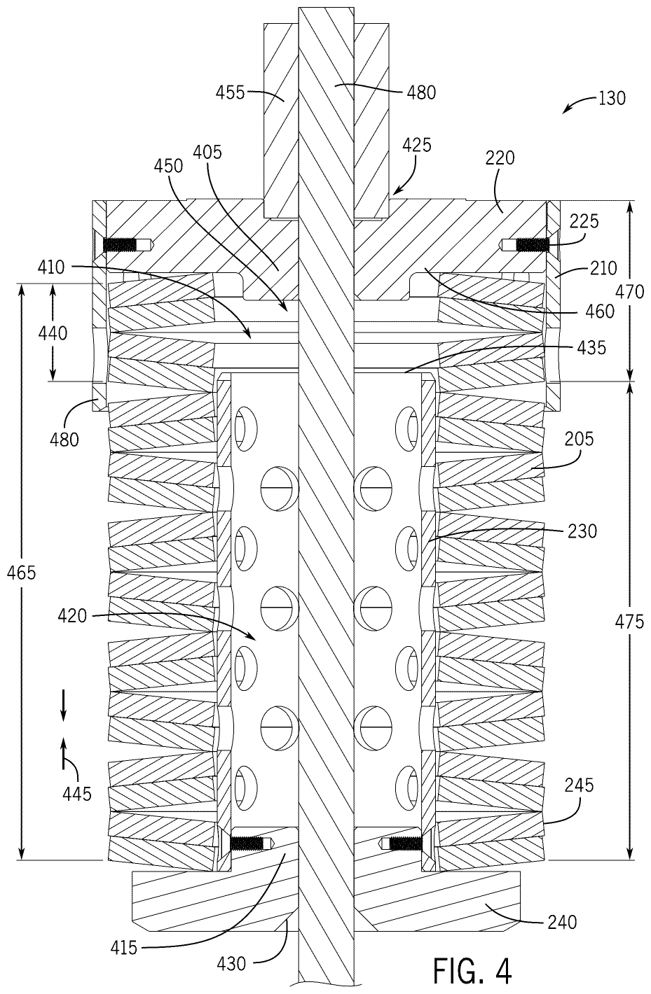

Generally, a spring guide can be provided to surround or be surrounded by the springs 205, to help maintain alignment of the springs 205 during operation of the valve 100. In particular, as noted above, a spring guide can be useful to maintain radial alignment (i.e., alignment relative to the radial direction, with respect to a common central axis). In some examples, in order to maintain alignment of the springs 205 within the spring assembly 130, the spring assembly may include a first spring guide 210 and a second spring guide 230. In one example, the first spring guide 210 is configured to circumferentially surround a portion of an exterior surface 250 of the springs 205 along a portion of the axial collective length of the springs 205, and thus to surround a corresponding set of the springs 205 (e.g., some, as shown). Correspondingly, as shown in FIG. 4 in particular, the second spring guide 230 is configured to extend at least partially within central apertures 410 of the springs 205, to be received axially through a corresponding set of the springs 205 (e.g., all, as shown). Thus, when assembled, the second spring guide 230 may be nested within the central apertures 410 of the springs 205, while the springs 205 may be nested within a central aperture 450 of the first spring guide 210.

In this regard, generally, an inner guide surface (e.g., an inner cylindrical surface) of the first spring guide 210 can surround and face toward a first set of the springs 205 (e.g., a partial set of the springs 205) and an outer guide surface (e.g., an outer cylindrical surface) of the second spring guide 230 can be surrounded by and face toward a second set of the springs 205. For example, as shown in FIG. 4, the inner guide surface of the first spring guide 210 can surround and face radially inward toward a partial set of the springs 205 that is adjacent to a first spring washer 220, and the outer guide surface of the second spring guide 230 can be surrounded by and face radially outward toward a larger partial set of the springs 205 that is adjacent to a second spring washer 240 and that includes some springs 205 in common with the partial set surrounded by the first spring guide 210.

In some examples, the first spring guide 210 may define a length 470 that is approximately 30-50 percent of a length 475 of the second spring guide 230. Thus, the second spring guide 230 may provide a majority of the guidance to the springs 205 during compression of the springs 205. Further, in some cases, the length 470 of the first spring guide 210 may be designed so that an axial end 480 of the first spring guide 210 overlaps with an axial end 435 of the second spring guide 230. As noted above, however, some examples may include only one of the spring guides (e.g., spring guides 210, 230, 810).

In some examples, in order to mitigate the risk of over-heating of the springs 205, the first and second spring guides 210, 230 may each define one or more openings 215, 235 (e.g., extending radially through the corresponding cylindrical guide surface). The openings 215, 235 may permit the flow of fluid (e.g., air) through the spring assembly 130 to cool the springs 205. Thus, the risk of over-heating the springs 205, which may affect one or more mechanical characteristics (e.g., spring constant, etc.) of the springs 205, may be mitigated. In some cases, the openings 215 may further serve to reduce the overall weight and material usage of the spring assembly 130. Further, to save weight of the spring assembly 130, the first and second spring guides 210, 230 may be made from a lightweight metallic material (e.g., aluminum). However, in other examples, the spring guides 210, 230 may be made from other materials (e.g., other metallic materials, polymeric materials, carbon fiber, etc.).

As shown in FIG. 4, in particular, In some examples, the springs 205 may be secured between the first spring washer 220 and the second spring washer 240. In particular, the springs 205 may be partially compressed between the first spring washer 220 and the second spring washer 240, so that the springs 205 apply a biasing force to the valve stem 125 to close the relief valve 100.

Thus, in some examples, the biasing force applied by the springs 205 may correspond to an amount of compression force applied to the springs 205 via the first and second spring washers 220, 240. Correspondingly, as mentioned previously, the amount of compression force applied to the springs 205 may be adjusted via a spring adjustment screw 455 in contact with the first spring washer 220. A spindle 480 of the valve stem 125 to guide movement of the valve trim may further be arranged through the central apertures 410, 420 of the springs 205 and the second spring guide 230, respectively, as well as through openings 425, 430 of the spring washers 220, 240. In some examples, the relief valve 100 may include a spindle assembly. The spring assembly may include the valve trim 110, the spindle 480, and the spring assembly 130, among other components of the relief valve 100.

In some examples, the first spring guide 210 and the second spring guide 230 may be secured to respective first and second spring washers 220, 240. For example, the first spring guide 210 may be secured to the first spring washer 220 via one or more fasteners 225 arranged through the first spring guide 210 into the first spring washer 220. Correspondingly, the second spring guide 230 may be secured to the second spring washer 240 via one or more fasteners 245. In particular, the one or more fasteners 245 may extend through the second spring guide 230 into a pedestal 415 nested within the central opening 420 of the second spring washer 240. In some examples, the fastener(s) 245 may be in the form of screws, bolts, rivets, nuts, or any other known fastener. In one particular example, the fastener(s) 245 may include a washer (e.g., a split washer or lock washer) to mitigate the risk of vibration loosening the fasteners 245.

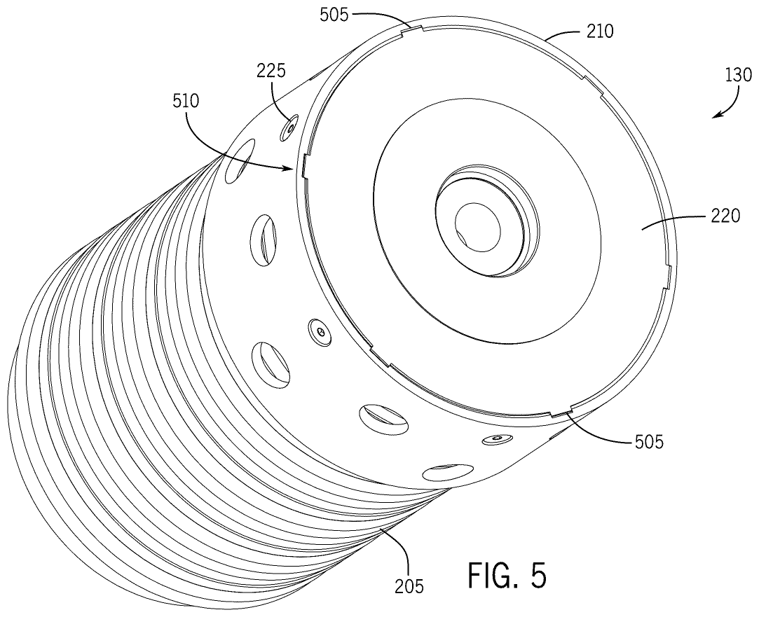

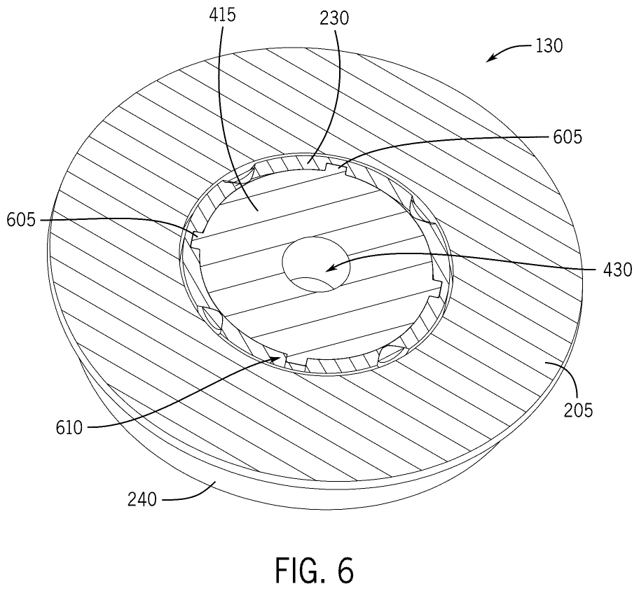

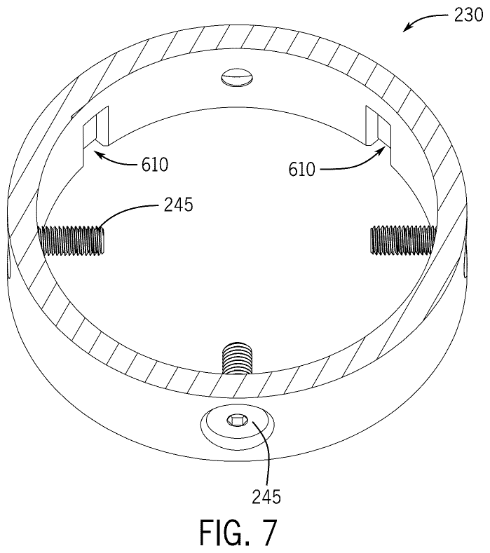

With reference to FIGS. 5-7, in some examples, to assist in alignment of the spring assembly 130, the spring assembly 130 may include an alignment system. In some cases, the alignment system may assist operators in manufacturing (e.g., assembly) of the spring assembly 130. For example, as shown in FIG. 5 in particular, the first spring washer 220 may include one or more alignment tabs 505 configured to engage with one or more corresponding alignment slots 510 of the first spring guide 210 (or vice versa) to align and prevent relative rotation between the first spring washer 220 and the first spring guide 210. Similarly, as shown in FIGS. 6 and 7 in particular, the second spring washer 240 may include one or more alignment tabs 605 extending from the pedestal 415 and the second spring guide 230 may include one or more corresponding alignment grooves 610 (or vice versa). The alignment tabs 605 may be configured to engage with the one or more corresponding alignment grooves 610 of the second spring guide 230 to align and prevent relative rotation between the second spring washer 240 and the second spring guide 230. In some examples, with the alignment tabs engaged with the alignment slots, rotation of the spring assembly 130 may be mitigated in particular during adjustment of the spring adjustment screw 455. Further, during assembly of the spring assembly 130, an operator may use the alignment tabs and alignment slots to confirm proper assembly of the spring assembly 130.

With reference again to FIG. 4, in some examples, to facilitate the movement (e.g., compression/expansion) of the springs 205, the spring assembly 130 may define a gap 440, in an axial or compression direction, between the first axial end 435 of the second spring guide 230 and an axial face 460 the first spring washer 220. In use, as a length 465 of the springs 205 is reduced (i.e., via compression of the springs 205), the gap 440 may be similarly reduced (e.g., the distance between the first edge 435 and the face 460 may be reduced), but not eliminated. Thus, over a rated range of motion, the springs 205 may be compressed without the risk of contact between the first axial end 435 of the second spring guide 230 and the face 460 of the first spring washer 220.

In some examples, during compression of the springs 205 (e.g., as shown by arrows 445), a pedestal 405 of the first spring washer 220 may protrude within the central opening 420 of the second spring guide 230 (e.g., past the first edge 435 of the second spring guide 230). In some cases, the pedestal 405 may reduce the risk of misalignment of the springs 205 when compressed.

In some examples, a gap in a radial direction can be provided between the springs 205 and, respectively, the first and second spring guides 210, 230. In some examples, to maintain this gap and thereby facilitate guidance of the springs 205 without generating additional frictional force, the tolerances for clearances between various components of the spring assembly 130 may be predetermined. For example, a radial clearance between the springs 205 and the first spring guide 210 may be about 0.03 inches and a radial clearance between the springs 205 and the second spring guide 230 may be about 0.04 inches. As should be appreciated, the clearances between the springs 205 and the first and second spring guides 210, 230 may be larger or smaller depending on the intended use case (e.g., to accommodate for expected thermal expansion or other factors).

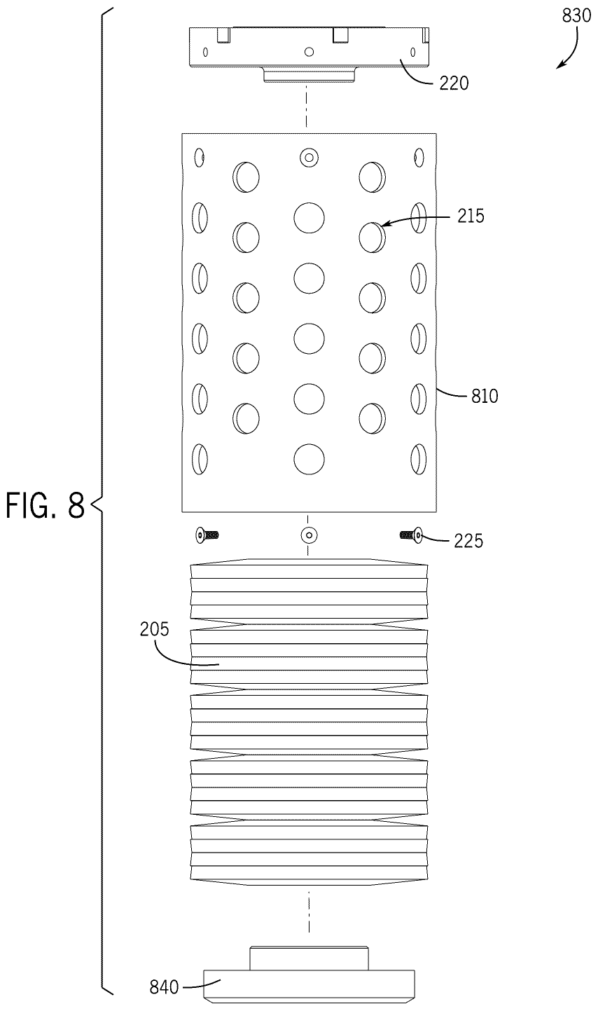

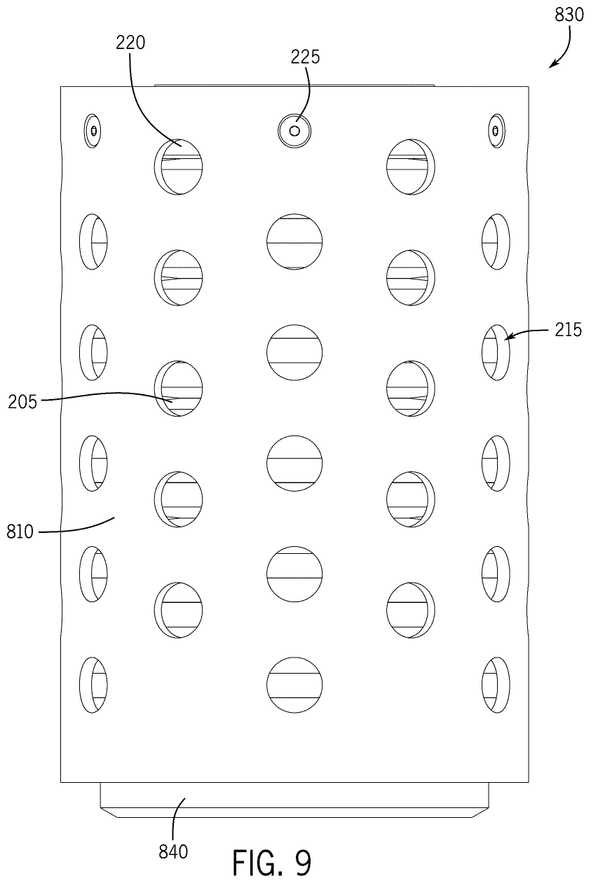

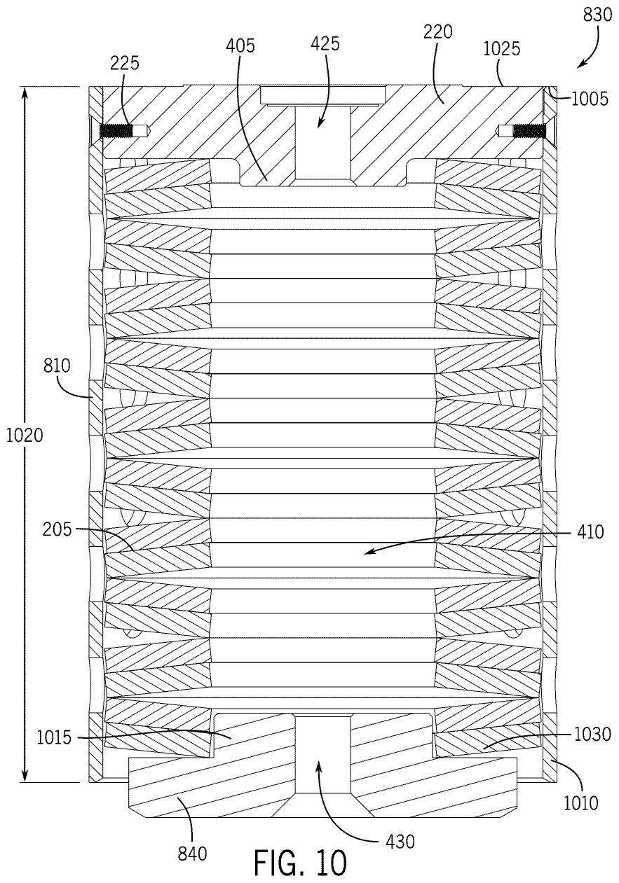

FIGS. 8-10 illustrate another example of a spring assembly 830 that can be used with the relief valve 100 of FIG. 1 (e.g., as an alternative configuration of the spring assembly 130). As will be recognized, the spring assembly 830 shares a number of components in common with and operates in a similar fashion to the examples illustrated and described previously. For the sake of brevity, these common features will not be again described below in detail. Rather, previous discussion of similarly named or numbered features (e.g., relative to the spring assembly 130, unless otherwise indicated, also applies to example configurations of the spring assembly 830.

In some examples, instead of including both the first and second spring guides 210, 230, the spring assembly 830 may include only a single spring guide 810. Similar to the first spring guide 210, the spring guide 810 may surround the springs 205 and correspondingly provide an inner (e.g., cylindrical) guide surface that faces radially inwardly toward the springs 205. Also similar to the first spring guide 210, the spring guide 810 may include one or more openings 815, which may permit the flow of fluid (e.g., air) through the spring assembly 830. As mentioned previously, it may be advantageous to permit the flow of air through the spring assembly 830 to mitigate risk of overheating of the spring assembly 830, which may affect function of the spring assembly 830 (e.g., via modification of a spring rate of the springs 205). Further, the one or more openings 815 may reduce the overall weight of the spring assembly 830 (e.g., via reducing the weight of the spring guide 810).

In some examples, as the spring assembly 830 may not include an inner spring guide (e.g., similar to the second spring guide 230), a length 1020 of the spring guide 810 may extend from the first spring washer 220 past an opposite axial end 1030 of the springs 205 (e.g., to overlap axially with the second spring washer 840). Thus, the springs 205 may be fully nested within the spring guide 810 in an operational (e.g., pre-compressed) configuration (e.g., with the springs 205 compressed at a default pressure for the corresponding valve). As a result, the spring guide 810 may maintain alignment of the springs 205 throughout movement of the springs 205 and the spring assembly 830 generally.

In some examples, to further align the springs 205, a pedestal 1015 of the second spring washer 840 may extend within the central aperture 410 of the springs 205. For example, the pedestal 1015 may extend past the end 1030 of the springs 205 in an opposite direction as the spring guide 810. Thus, radial movement of the springs 205 may be mitigated.

In some examples, to facilitate movement (e.g., compression and expansion) of the springs 205, only one end of the spring guide 810 may be fixed, while another opposite end of the spring guide 810 may be free-floating. For example, the spring guide 810 may be secured to the first spring washer 220 at a first end 1005 of the spring guide 810 (e.g., via the one or more fasteners 225), but a second end 1010 of the spring guide 810 may not be secured to the second spring washer 840. Put differently, only a single end (e.g., first end 1005) of the spring guide 810 may be fixed, with the other end (e.g., second end 1010) supported in a cantilevered arrangement to permit movement (e.g., compression or expansion) of the springs 205.

In some examples, a gap in a radial direction can be provided between the springs 205 and the second spring washer 840. In some examples, to maintain this gap and thereby facilitate guidance of the springs 205 without generating additional frictional force, the tolerances for clearances between various components of the spring assembly 830 may be predetermined. For example, a radial clearance between the springs 205 and the pedestal 1015 of the second spring washer 840 may be about 0.04 inches. As should be appreciated, the clearance between the springs 205 and the pedestal 1015 may be larger or smaller depending on the intended use case.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A spring assembly for a spring-operated relief valve, the spring assembly comprising:
a first spring washer;
a second spring washer;
a plurality of springs arranged between the first spring washer and the second spring washer to be compressed by movement of the second spring washer toward the first spring washer; and
a first spring guide secured relative to the first spring washer, the first spring guide defining one of:
a central guide opening that defines a first inner guide profile that receives one or more springs of the plurality of springs; or
a first outer guide profile that is received within one or more springs of the plurality of springs;
during compression of the plurality of springs by movement of the second spring washer toward the first spring washer, the one of the first inner or first outer guide profiles of the first spring guide maintaining radial alignment of the plurality of springs relative to the first and second spring washers.

2. The spring assembly of claim 1, further comprising:
a second spring guide;
wherein the first spring guide defines the central guide opening that receives the one or more springs of the plurality of springs; and
wherein the second spring guide defines a second outer guide profile that is received within the one or more springs of the plurality of springs to further maintain radial alignment of the plurality of springs relative to the first and second spring washers.

3. The spring assembly of claim 2, wherein the first spring guide is a first spring guide cylinder secured to an outer diameter of the first spring washer; and
wherein the second spring guide is second spring guide cylinder secured to an inner pedestal of the second spring washer.

4. The spring assembly of claim 2, wherein a length of the first spring guide between the first and second spring washers is between about 30 percent and about 50 percent of a length of the second spring guide between the first and second spring washers.

5. The spring assembly of claim 2, wherein the first spring guide extends axially from the first spring washer toward the second spring washer; and
wherein the second spring guide extends axially from the second spring washer toward the first spring washer, to axially overlap with the first spring guide.

6. The spring assembly of claim 1, wherein the first spring guide defines the central guide opening; and
wherein a length of the first spring guide in a direction of compression of the plurality of springs is longer than a collective length of the plurality of springs in the direction of compression, as measured with the plurality of springs in a pre-compressed state corresponding to the spring-operated relief valve being in a closed configuration.

7. The spring assembly of claim 1, wherein the first spring guide defines a plurality of thru-openings along the one of the first inner guide profile or the first outer guide profile to provide gas exchange to cool the plurality of springs.

8. The spring assembly of claim 1, wherein the plurality of springs include a plurality of disk springs.

9. The spring assembly of claim 1, wherein the first spring guide defines the first outer guide profile; and
wherein one or more of:
an axial gap is defined, in a direction of compression of the plurality of springs, between the first spring guide and the second spring washer, the axial gap permitting compression of the plurality of springs to open the spring-operated relief valve without contact between the first spring guide and the second spring washer; or
a radial gap is defined in a radial direction between the plurality of springs and the one of the first inner guide profile or the first outer guide profile, the radial gap permitting radial movement of the first spring guide relative to the plurality of springs.

10. A spring-operated relief valve comprising:
a valve body that defines an inlet and an outlet;
a valve seat along a flow path between the inlet and the outlet;
a spindle assembly, including:
a valve trim assembly;
a spindle; and
a spring assembly, including:
a first spring washer;
a second spring washer engaged with the spindle assembly to be moved toward the first spring washer by an opening movement of the valve trim assembly relative to the valve seat;
a plurality of springs arranged between the first spring washer and the second spring washer to be compressed by movement of the second spring washer toward the first spring washer; and
a first spring guide cylinder extending circumferentially around the spindle and defining one of:
a central guide opening that defines a first cylindrical inner guide profile that extends circumferentially around one or more of the plurality of springs; or
a first cylindrical outer guide profile that is received through one or more of the plurality of springs.

11. The spring-operated relief valve of claim 10, further comprising:
a second spring guide cylinder secured to the second spring washer;
wherein the first spring guide cylinder defines the central guide opening and extends circumferentially around a first set of the plurality of springs; and
wherein the second spring guide cylinder defines a second cylindrical outer guide profile that is received through a second set of the plurality of springs to further maintain radial alignment of the plurality of springs.

12. The spring-operated relief valve of claim 10, wherein the first spring guide cylinder defines the central guide opening; and
wherein a length of the first spring guide cylinder in a direction of compression of the plurality of springs is longer than a collective length of the plurality of springs in the direction of compression, as measured with the plurality of springs in a pre-compressed state corresponding to the spring-operated relief valve being in a closed configuration.

13. The spring-operated relief valve of claim 10, wherein the first spring guide cylinder defines a plurality of thru-openings along the one of the first cylindrical inner guide profile or the first cylindrical outer guide profile to provide gas exchange to cool the plurality of springs.

14. The spring-operated relief valve of claim 10, further comprising:
a pressure adjustment assembly engaged with the spring assembly to adjust a compression of the plurality of springs and thereby adjust a set pressure of the spring-operated relief valve.

15. The spring-operated relief valve of claim 10, wherein the first spring washer includes one or more alignment tabs and the first spring guide cylinder includes one or more corresponding alignment slots configured to engage with the one or more alignment tabs to prevent relative rotation between the first spring washer and the first spring guide cylinder.

16. A method of assembling a spring assembly for a spring-operated relief valve, the method comprising:
positioning a plurality of springs between a first spring washer and a second spring washer;
securing a first spring guide relative to the first spring washer, the first spring guide defining one of:
a central guide opening that defines a first inner guide profile that receives one or more springs of the plurality of springs; or
a first outer guide profile that is received within one or more springs of the plurality of springs; and
the securing of the first spring guide aligning the one of the first inner or first outer guide profiles of the first spring guide to maintain radial alignment of the plurality of springs relative to the first and second spring washers, during compression of the plurality of springs by movement of the second spring washer toward the first spring washer.

17. The method of claim 16, wherein the first spring guide defines the central guide opening, the method further comprising:
securing a second spring guide relative to the second spring washer, the second spring guide defining a second outer guide profile that is received within the one or more springs of the plurality of springs to further maintain radial alignment of the plurality of springs.

18. The method of claim 16, wherein the securing of the first spring guide relative to the first spring washer includes:
engaging one or more alignment tabs of the first spring washer with one or more corresponding alignment slots of the first spring guide to prevent relative rotation between the first spring washer and the first spring guide.

19. The method of claim 16, wherein the first spring guide defines a plurality of thru-openings to provide gas exchange to cool the plurality of springs during operation of the spring-operated relief valve.

20. The method of claim 16, wherein a length of the first spring guide in a direction of compression of the plurality of springs is longer than a collective length of the plurality of springs in the direction of compression, as measured with the plurality of springs in a pre-compressed state.
